(19) United States
(12) Patent Application Publication
(10) Pub. No.: US 2010/0131804 A1
(43) Pub. Date: May 27, 2010

(54) METHOD AND APPARATUS FOR SYMMETRY REDUCTION IN DISTRIBUTED MODEL CHECKING

(75) Inventors: Kuntal DasBarman, Bangalore (IN); Karan Sehgal, Bangalore (IN)

Correspondence Address: HONEYWELL/FOGG;Patent Services, 101 Columbia Road, P.O Box 2245, Morristown, NJ, 07962-2245, US

(73) Assignee: Honeywell International Inc., Morristown, NJ (US)

(21) Appl. No.: 12/324,626

(22) Filed: Nov. 26, 2008

(51) Int. Cl. G06F 11/08

(52) U.S. Cl. 714/52; 714/E11.03

(57) ABSTRACT

A method for a model checking algorithm is provided. The method includes determining whether a class representative for a state has been processed, and generating a successor state for the state when the class representative for the state has not been processed. The method also includes determining which of a plurality of nodes is assigned to process the successor state, and processing the successor state at a node of the plurality of nodes that is assigned to process the successor state.

Additionally another method for checking a model of a system is provided. This method processes a plurality of states for the model with a plurality of nodes using a distributed model checking technique. Each of the plurality of nodes uses symmetry reduction techniques to check if a representative state for a first state has been processed prior to processing the first state.

### BACKGROUND

One method used for testing a system prior to implementation is to represent the operation of the system as a mathematical model having a plurality of states. The model and its corresponding states are then analyzed to “test” for errors in the operation of the system. This is sometimes referred to as model checking. Each model is comprised of a plurality of states for the system which the model is checking. Each state is a unique configuration of the system that may occur during operation of the system. Model checking checks each state of the system to determine if there are any errors that will occur for the system in that state.

Automatic formal verification is one form of model checking that enumerates all the reachable states of a system. The state space for automatic formal verification methods may grow very rapidly with the description size and may become unmanageably large. This problem is known as state space explosion. State space explosion is often a problem in automatic formal verification of finite state systems. This is true even for smaller systems when, for example, the systems have complex safety-critical requirements.

Several approaches have been considered to overcome the state space explosion problem. The approaches can be divided into three categories. The first approach is to reduce to the number of states. Partial order reduction, symmetry reduction, and minimized deterministic finite automation (DFA) are three main techniques in this category. These techniques attempt to intelligently remove unnecessary states from the state graph. The second approach is to reduce the size of the states. Program slicing, state compression, bit state hashing, and symbolic model checking are some of the techniques in this category. The third approach is to increase the physical memory and computation power of the machine. Distributed model checking is an example of a technique in this category.

### SUMMARY

The following summary is made by way of example and not by way of limitation. In one embodiment, a method for a model checking algorithm is provided. The method includes determining whether a class representative for a state has been processed, and generating a successor state for the state when the class representative for the state has not been processed. The method also includes determining which of a plurality of nodes is assigned to process the successor state, and processing the successor state at a node of the plurality of nodes that is assigned to process the successor state.

Additionally another method for checking a model of a system is provided. This method processes a plurality of states for the model with a plurality of nodes using a distributed model checking technique. Each of the plurality of nodes uses symmetry reduction techniques to check if a representative state for a first state has been processed prior to processing the first state.

### DRAWINGS

FIG. 1 is a block diagram illustrating one embodiment of a system for implementing a model checking algorithm; and

FIG. 2 is a flow chart illustrating one method for a model checking algorithm.

### DETAILED DESCRIPTION

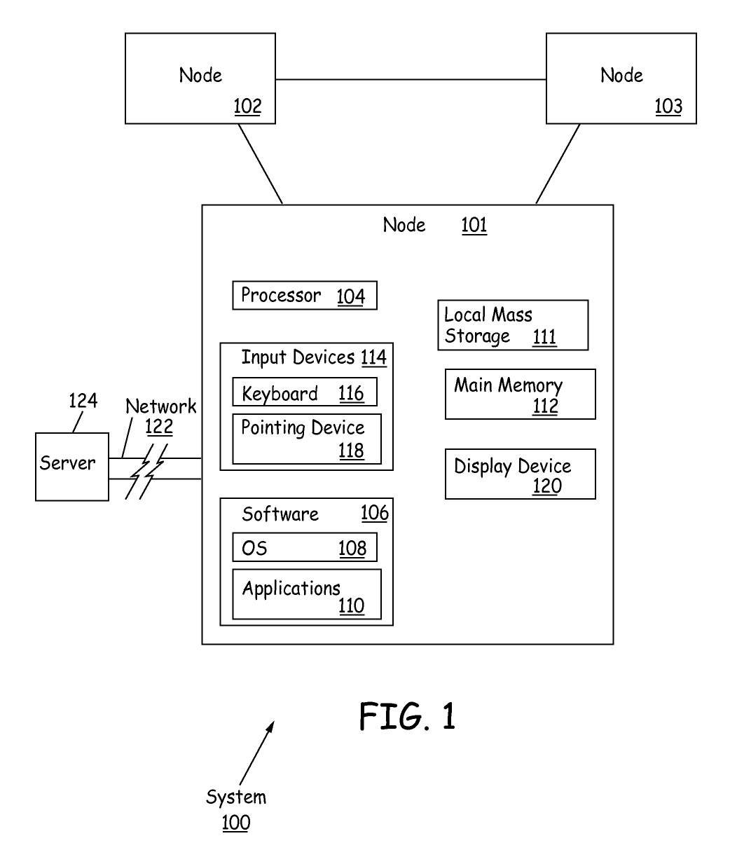

FIG. 1 is a high-level block diagram of one embodiment of a processing system 100 for implementing a model checking algorithm. Processing system 100 comprises a plurality of nodes 101, 102, 103 which are communicatively coupled to one another. Each node 101, 102, 103 is a processing location for the model checking algorithm. In other words, the model checking algorithm uses each of the plurality of nodes 101, 102, 103 to perform part of the total calculation needed to complete the algorithm. In one embodiment, nodes 101, 102, 103 are coupled through an Ethernet network interface. In other embodiments, other interfaces are used to communicatively couple together nodes 101, 102, 103. As shown in FIG. 1 each node 101, 102, 103 has direct communication with the other nodes 101, 102, 103, however, in other embodiments, indirect communication is used between nodes 101, 102, 103. Furthermore, in FIG. 1, only node 101 is shown in detail, however, it should be understood that in this embodiment, nodes 102, 103 are similar in construction and function to node 101. Finally, although for ease of illustration three nodes 101, 102, 103 are shown in FIG. 1, in other embodiments, more, or fewer than three nodes are used.

Node 101 comprises at least one programmable processor 104. Processor 104 executes various items of software 106. In the embodiment shown in FIG. 1, software 106 executed by processor 104 comprises an operating system (OS) 108 and one or more applications 110. Software 106 comprises program instructions that are embodied on one or more items of processor-readable media (for example, a hard disk drive 111 (or other mass storage device) local to node 101 and/or shared media such as a file server that is accessed over a network (such as a local area network or wide area network such as the Internet). For example in one such embodiment, software 106 is executed on node 101 and stored on a file server 124 that is coupled to node 101 over, for example, a network 122. In such an embodiment, node 101 retrieves software 104 from the file server over the network in order to execute software 104. In other embodiments, such software is delivered to node 101 for execution thereon in other ways. For example, in one such other embodiment, software 104 is implemented as a servelet (for example, in the JAVA programming language) that is downloaded from a hypertext transfer protocol (HTTP) server and executed using an Internet browser running on node 101. Each node 101, 102, 103 of processing system 100 can be implemented in various form factors and configurations including, for example, as a desktop computer, portable computer, and network computer.

Typically, a portion of software 106 executed by processor 104 and one or more data structures used by software 106 during execution are stored in a main memory 112. Main memory 112 comprises, in one embodiment, any suitable form of random access memory (RAM) now known or later developed, such as dynamic random access memory (DRAM). In other embodiments, other types of memory are used.

Node 101 comprises one or more local mass storage devices 111 such as hard disk drives, optical drives such as compact disc read-only memory (CDROM) drives and/or digital video disc (DVD) optical drives, USB flash drives, USB hard disk drives, and floppy drives. In some implementations, the data storage media and/or the read/write drive mechanism itself is removable (that is, can be removed from node 101). Node 101 also comprises appropriate buses and interfaces for communicatively coupling such local mass storage devices 111 to processor 104 and the components thereof.

One or more input devices 114 are communicatively coupled to node 101 by which a user (or other source) is able to provide input to node 101. In the embodiment shown in FIG. 1, input devices 114 comprise a keyboard 116 and a pointing device 118 (such as a mouse or a touch-pad). In other implementations (for example, where node 101 comprises a portable computer), keyboard 116 and pointing device 118 are integrated into node 101. In some of those implementations, a keyboard and/or pointing device external to the portable computer can also be communicatively coupled to node 101. In one embodiment, input devices 114 are located remotely from processor 104. In such an embodiment, input devices 114 are communicatively coupled to processor 104 and main memory 112 through a network or other long distance mechanisms as known to those skilled in the art.

One or more display devices 120 are communicatively coupled to node 101 on or by which node 101 is able to display output for a user. In some other implementations of the embodiment shown in FIG. 1, node 101 comprises one or more interfaces by which one or more external display devices are communicatively coupled to node 101. In other implementations (for example, where computer 100 comprises a portable computer), display device 120 comprises a display that is integrated into node 101 (for example, an integrated liquid crystal display). In some of those implementations, node 101 also includes one or more interfaces by which one or more external display devices (for example, one or more external computer displays) can be communicatively coupled to node 101. In one embodiment, display devices 120 are located remotely from processor 104. In such an embodiment, display devices 120 are communicatively coupled to processor 104 and main memory 112 through a network or other long distance mechanisms as known to those skilled in the art.

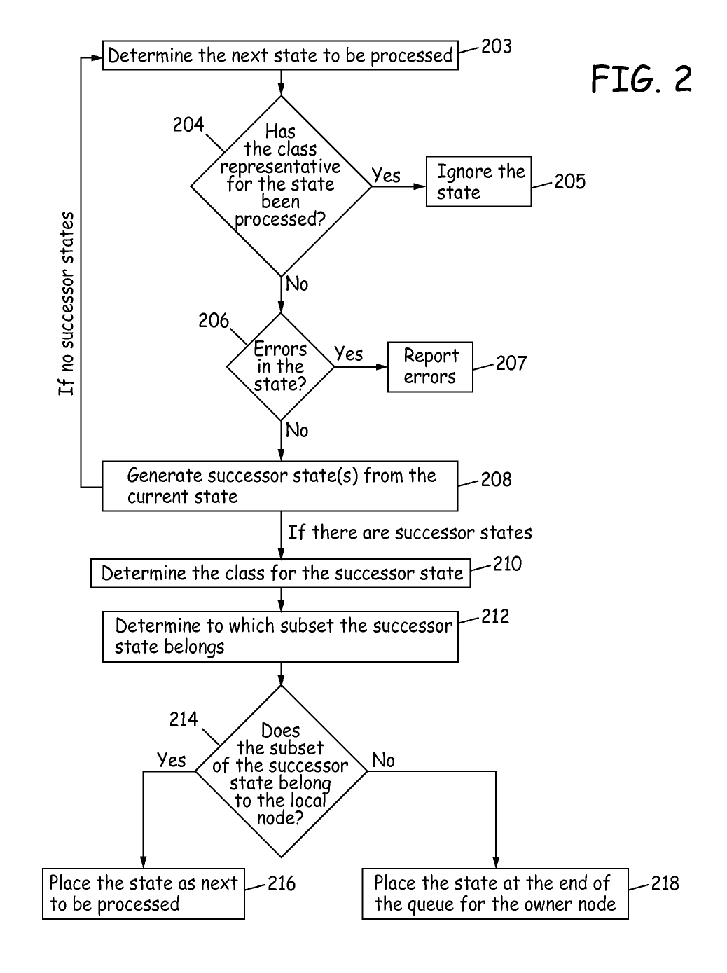

Referring now to FIG. 2, one embodiment of a method 200 for checking a software model of a formal system is illustrated. Method 200 combines the use of symmetry reduction techniques and distributed model checking. Symmetry reduction reduces the state space size by exploiting symmetries in the structure of the formal system to be verified. Each group of symmetric states is placed into a class. For verification, it is sufficient to explore only one state per class. Thus, symmetry reduction divides the state space into a plurality of classes and explores only one of the states in each class thereby reducing the required processing. More detail regarding symmetry based reduction techniques is provided in the following references which are hereby incorporated herein by reference: From Distributed Memory Cycle Detection to Parallel LTL Model Checking by J. Barnat, L. Brim and J. Chaloupka, FMICS 2004; Better Verification Through Symmetry by C. Norris Ip and David L. Dill, Formal Methods in System Design 1996; Adding Symmetry reduction to UPPAAL by M. Hendriks, G. Behrmann, K. Larsen, P. Niebert and F. Vaandrager, FORMATS 2003; Symmetric Spin by D. Bo\check{s}na\check{c}ki, D. Dams and L. Holenderski, SPIN 2000; A Heuristic for Symmetry Reductions with Scalarsets by D. Bo\check{s}na\check{c}ki, D. Dams and L. Holenderski, FME 2001; Structural Symmetry and Model Checking by G. S. Manku, R. Hojati and R. Brayton, CAV 1998; and Symmetry Reduction Criteria for Software Model Checking by Radu Iosif, SPIN 2002.

Distributed model checking distributes the processing of the state graph over a cluster of nodes (for example, nodes 101, 102, 103). This enables generation and verification of the state graph in parallel at each node 101, 102, 103. More detail regarding distributed model checking algorithms is provided in the following articles each of which is hereby incorporated by reference: Distributed LTL Model-Checking in SPIN by J. Barnat, L. Brim, and J. Stribrna, SPIN 2001; Distributed LTL Model Checking Based on Negative Cycle Detection, by L. Brim, I. Cerna, P. Krcal, and R. Pelanek, FSTTCS 2001; Distributed-Memory Model Checking with SPIN, by Flavio Lerda and Riccardo Sisto, SPIN 1999; and Parallelizing the Mury Verifier, by Ulrich Stern and David L. Dill, CAV 1997.

To implement method 200, the distributed model checking algorithm is modified to incorporate symmetry reduction in a distributed setting. Method 200 reduces the state space size with the help of the symmetry reduction technique and generates the symmetry reduced state graph in a distributed manner. In one embodiment, method 200 is based on a nested depth first search (DFS) algorithm. Since method 200, however, is implemented in a distributed setting, method 200 does not follow an exact DFS order, because of the parallel processing at each node. In another embodiment, method 200 is a breadth first search algorithm. FIG. 2 and the description of method 200 below, follow a single state through the algorithm. Before method 200 begins, a state space for a model is divided into a number of subsets equal to a number of nodes 101, 102, 103 of system 100. The state space is a description of the configuration of states for system 100. Each node 101, 102, 103 “owns” one of the state subsets and is responsible for holding and processing states in the subset that the node 101, 102, 103 owns respectively. Additionally, prior to starting method 200, a plurality of classes for the state space are determined. The plurality of classes is used to implement a symmetry reduction technique by processing only a representative state for each class as explained below.

Method 200 begins at block 202 where a node 101 determines the next state to be processed. States that are processed may be states generated at node 101 or states generated at another node 102, 103. States that are generated by node 101 are processed in sequence from a higher order of the recursive method 200 as shown in FIG. 2 and explained below. States that are generated at other nodes 102, 103 are placed in a queue at node 101 and processed by node 101 in sequence. More detail regarding generation of states and the order in which they are processed is provided below.

Once the new state is determined as the next to be processed, symmetry reduction is performed on the new state. For example, at block 204, node 101 determines if the class representative for the state has already been processed. To determine if the class representative for the state has been processed, node 101 matches the class in which the state belongs to a class representative and determines if that class representative has been processed. The class to which the state belongs is determined at the time the state was generated. The process of determining the class for a state is described below with respect to block 210. If the class representative for the node has been processed, method 200 proceeds to block 205 where node 101 discards the state. After that state has been discarded, method 200 begins again by determining the next state to be processed (if any) at block 202. If the class representative for the node has not been processed, node 101 continues processing the state at block 206.

To determine the class representatives, a canonicalization function is used that maps every state of an equivalence class to a unique member of that class. A canonicalization function is a function that finds the class representative for a state. The canonicalization function is then used to construct the reduced graph for verification. For example, a program has a set of variables which along with a program counter define a state of the program. In one embodiment, the program has concurrent processes such that multiple sets of program counters and variables represent a state. For example, if the program has processes p1, p2, . . . p9. Let their program counters be pc1, pc2, . . . pc9 and their variables be {V1}, {V2}, . . . {V9}. The state of the program is ({pc1, {v1}}, {pc2,{v2}}, . . . {pc9,{v9}}). In one embodiment, the process ids are also included in the state presentations, all variables are assumed to be global, and program counters are considered variables. The state vector therefore becomes {p1, {pc1,{V1}}, p2, {pc2,{V2}}, . . . p9, {pc9, {V9}}}. The state vector may also be written as (p1, p2, . . . p9, {pc1,{V1}}, {pc2,{V2}}, . . . {pc9, {V9}}).

Two matching states such as state 1—1100101100 and state 2—1100101100 may be represented in different manners. Each manner of representing a matching state, however, is symmetrical to other manners of representing the matching state. Thus, if state 1 and state 2 are represented in a manner such that every two bits is a letter, 1100101100 can be abcde (where a=11, b=00, c=10, d=11, and e=00). 1100101100 can also be dbcae or aecdb or some other permutation. Symmetry between two states is found if values of two permutations of a state vector are the same. For example, if the permutation for state 1 is p1-p2-p4-p5-p3-p7-p8-p6-p9 and the permutation for state 2 p6-p2-p9-p5-p3-p7-p8-p4-p1, the vectors their state vector looks like ({pc1,{V1}}, {pc2,{V2}}, {pc4,{V4}}, {pc5,{V5}}, {pc3,{V3}}, {pc7,{V7}}, {pc8,{V8}}, {pc6,{V6}}, {pc9,{V9}}) and ({pc6,{V6}}, {pc2,{V2}}, {pc9,{V9}}, {pc9,{V5}}, {pc3,{V3}}, {pc7,{V7}}, {pc8,{V8}}, {pc4,{V4}}, {pc1,{V1}}) respectively. If these two state vectors are equal then these state vectors are symmetric. Two state vectors are equal if the values of {pc1,{V1}} and {pc6,{V6}} are equal, and {pc2,{V2}} and {pc2, {V2}} are equal, and so on . . . till the last tuple.

To determine who represents a class “on the fly” when states are generated during the run with know a prior information known about the class of the states, heuristics are applied. Strategies known as full, sorted, segmented, pc-sorted, and pc-segmented may be used as a canonicalization function. For a full strategy all a permutations are applied. For example, in the above example, a full strategy results in 9! or 362,880 permutations for each state vector. In a sorted strategy all permutations are sorted using a defined algorithm and one permutation is picked and applied over all state vectors. For example, in the above example the permutation abcde may be chosen instead of dbcae or aecdb. For a segmented strategy, all permutations are sorted using a defined algorithm and the segment where each state vector starts is determined. This segment is further sorted using some other sorting algorithm and one permutation is picked and applied over all vectors. Additionally, the sorted and segmented strategies may be based on program counter variables. This is known as pc-sorted and pc-segmented strategies.

More detail regarding canonicalization functions, and strategies to determine a proper canonicalization functions are provided in the following articles: From Distributed Memory Cycle Detection to Parallel LTL Model Checking by J. Barnat, L. Brim and J. Chaloupka, FMICS 2004; Better Verification Through Symmetry by C. Norris Ip and David L. Dill, Formal Methods in System Design 1996; Adding Symmetry reduction to UPPAAL by M. Hendriks, G. Behrmann, K. Larsen, P. Niebert and F. Vaandrager, FORMATS 2003; Symmetric Spin by D. Bo\check{s}na\check{c}ki, D. Dams and L. Holenderski, SPIN 2000; A Heuristic for Symmetry Reductions with Scalarsets by D. Bo\check{s}na\check{c}ki, D. Dams and L. Holenderski, FME 2001; Structural Symmetry and Model Checking by G. S. Manku, R. Hojati and R. Brayton, CAV 1998; and Symmetry Reduction Criteria for Software Model Checking by Radu Iosif, SPIN 2002.

At block 206, it is determined whether there are any errors in the state. Here, method 200 checks for errors in the defined requirements or properties of the formal system being verified. If errors are found in the state, the model has failed and method 200 proceeds to block 207 where the errors method 200 enters a special error state and method 200 ends. If, however, no errors are found in the state, method 200 proceeds to block 208.

At block 208, one or more successor states are generated for the current state if applicable. If the current state has no successor states (referred to herein as a deadlock state), then there are no states to generate from the current state and method 200 begins again at block 202. If there are states to be generated from the current state, then at block 208 these successor states are generated. Once the successor states are generated, the current state is no longer needed and is marked as processed. From block 208, method 200 continues by processing successor states through blocks 210, 212 and 214.

At block 210, the class for a successor state is determined. This class is then stored with the successor state and used when the successor state is processed (in its own implementation of blocks 202-208) to determine if the class representative for the successor state has been processed. In one embodiment, the node 101, 102, 103 that generates the successor state calculates the class of the successor state using a canonicalization function. The canonicalization function creates scalarsets to detect symmetry in the description of the formal system. Scalarsets can only be accessed through restricted operations that guarantee certain symmetries to hold on the state graph. Additionally, polynomial time semantic analysis is done by a compiler to detect operations that violate the symmetries. Thus, the verifier does not risk unsoundness by exploiting invalid symmetries. More detail regarding canonicalization functions and scalarsets is provided in the following articles: From Distributed Memory Cycle Detection to Parallel LTL Model Checking by J. Barnat, L. Brim and J. Chaloupka, FMICS 2004; Better Verification Through Symmetry by C. Norris Ip and David L. Dill, Formal Methods in System Design 1996; Adding Symmetry reduction to UPPAAL by M. Hendriks, G. Behrmann, K. Larsen, P. Niebert and F. Vaandrager, FORMATS 2003; Symmetric Spin by D. Bo\check{s}na\check{c}ki, D. Dams and L. Holenderski, SPIN 2000; A Heuristic for Symmetry Reductions with Scalarsets by D. Bo\check{s}na\check{c}ki, D. Dams and L. Holenderski, FME 2001; Structural Symmetry and Model Checking by G. S. Manku, R. Hojati and R. Brayton, CAV 1998; and Symmetry Reduction Criteria for Software Model Checking by Radu Iosif, SPIN 2002.

At block 212, it is determined to which subset the successor state belongs. The processing of states is distributed across the plurality of nodes based on a distributed model checking distribution. Each node is assigned to process one or more subsets of the states. Thus, at block 212 it is determined to which subset of the states the successor state belongs. The subset is determined with a partition function. The partition function distributes the workload among nodes 101, 102, 103 of system 100 both in terms of memory and computation time. Additionally, in one embodiment, the partition function minimizes the communication overhead between nodes 101, 102, 103. Furthermore, in one embodiment, the partition function is designed for quick computation based on information mostly at the local node which is running the partition function.

In one embodiment a global hash function is used as the partition function. When a global hash function is used, the contents of every variable in the state vector are used. In another embodiment, a local hash function is used as the partition function. When a local hash function is used the contents of only those variables that are local to the node that is processing the corresponding state are used. In yet another embodiment, source code partitioning is used as the partitioning function. Here, the control flow graph of the source of each process is generated. Weights on the edges of this graph are associated by some user-defined means. This weighted graph is then partitioned into nodes. This partition is then used to partition the state graph.

In still another embodiment, a state vector element partition is used as the partition function. In this scheme a pre-run of the model checking is done to get a sample of the state space graph. The pre-run terminates after a pre-selected depth is reached. Once the sample graph is constructed the graph is partitioned using a multilevel graph partitioning scheme, based on the range of each element of the state vector. In other words, supervertices are formed by contracting several vertices into one based on the different values of the element in consideration. Each such supervertex is assigned a weight vector size of two. The first element says the memory requirements, the second element says about the computation requirements. This weighted graph with supervertices is then partitioned in recursive bisection manner, dividing in two parts at a time. This procedure is followed for each state vector element. The best partition is taken out of them and used to partition the entire state space graph in the original run.

More detail regarding partition functions is provided in the following articles each of which are hereby incorporated herein by reference: Distributed LTL Model-Checking in SPIN by J. Barnat, L. Brim, and J. Stribrna, SPIN 2001; Distributed-Memory Model Checking with SPIN, by Flavio Lerda and Riccardo Sisto, SPIN 1999; Analysis of Distributed Spin Applied to Industrial-Scale Models, by M. Rangarajan, Samar Dajani-Brown, K. Scholoegel, and D. Cofer, SPIN 2004; and Parallelizing the Murg Verifier, by Ulrich Stern and David L. Dill, CAV 1997.

Once the subset to which the successor state belongs is determined, method 200 proceeds to block 214 where it is determined whether the subset to which the successor state belongs is the subset assigned to node 101 which generated the successor state. If the subset for the successor state is the subset assigned to node 101, then method 200 proceeds to block 216 where method 200 begins again at block 202 using the successor state. If, however, the subset for the successor state matches the subset assigned to a different node (e.g. node 102), then method 200 proceeds to block 218 where the successor state is sent to node 102 the successor state is placed at the end of the queue for node 102 to process. Back at node 101, once the successor state has been sent to a node 102, method 200 begins again with the next state to be processed by node 101.

For example, in one embodiment, node 101 generates the successor state, and checks if the successor state belongs to its own subset or to the subset of another node (e.g. node 102). If the successor state belongs to the subset of node 101, node 101 processes the successor state. If, however, the successor state belongs to a subset assigned to node 102. Then node 101 sends a message containing the successor state to node 102. Node 102 receives the message and processes the successor state in sequence.

Along with the successor state, node 101 sends the “error path” leading to the successor state from the initial state. The error path is a list of the parent state of the current state, then the parent state's parent state, and so on all the way back to the initial state. Node 102 receives the successor state and the error path and adds the path to the list of paths representing its queue. The error path is used when an error is found, to trace the state path from the initial state to the state in which the error was found.

Method 200 generates the state graph in a manner similar to known DFS algorithms, such as that described in the following articles: Distributed LTL Model-Checking in SPIN by J. Barnat, L. Brim, and J. Stribrna, SPIN 2001; Distributed LTL Model Checking Based on Negative Cycle Detection, by L. Brim, I. Cerna, P. Krcal, and R. Pelanek, FSTTCS 2001; Distributed-Memory Model Checking with SPIN, by Flavio Lerda and Riccardo Sisto, SPIN 1999; and Parallelizing the Mury Verifier, by Ulrich Stern and David L. Dill, CAV 1997. Because of this, standard reachability analysis for verification of safety properties is used. For linear temporal logic (LTL) property verification, however, the “depth first order” is important and is difficult to support by method 200.

Although blocks 210, 212, 214, 216 and 218 are described above with respect to a single successor state created at block 208, when multiple successor states are created method 200 continues from block 208 by processing each successor state through blocks 210, 212, 214, 216, and 218. For example, in one embodiment three successor states are generated at block 208. The first successor state is processed through blocks 210, 212, and 214.

When the first successor state has reaches block 214, the first successor state has one of two options as mentioned above. The first option is block 216 where the successor state is processed at the node that created the successor state. The second option is to send the success state to another node for processing. When the first option (block 216) is followed, the first state is processed at the node that created the state. Then the node that created the state continues to processes the first successor state and proceed through another iteration of method 200 to generate all successor states from the first successor state. Once all the successor states have gone through their iterations of method 200, then the original implementation of method 200 processes the second successor state through blocks 210, 212, 214, 216, and 218. Referring back to the first successor state, when the second option (block 218) is followed, the first successor state is sent to another node, and then the original implementation of method 200 processes the second successor state through blocks 210, 212, 214, 216, and 218.

In either case, the second successor state the proceeds similar to the first successor state until all successor states from the second successor state have gone through their iterations of method 200. Then, the third successor state proceeds in the original iteration of method through blocks 210, 212, 214, 216, and 218. The operation of these blocks is commonly known as a recursive function.

Although method 200 is described by following a single state through a process, it should be understood that method 200 is implemented simultaneously across all nodes 101, 102, 103 of system 100 as is known for distributed model checking algorithms. Thus, each node 101, 102, 103 processes states that are received from other nodes 101, 102, 103, and each node 101, 102, 103 also sends states to other nodes 101, 102, 103 for processing.

The overall process is terminated once all nodes 101, 102, 103 across system 100 have no states to process. When a node 101, 102, 103 is not processing and does not have any states to process the node 101, 102, 103 is considered idle. In one embodiment, to ensure proper termination of method 200 a manager process is created. The manager process communicates with nodes 101, 102, 103 to find out whether nodes 101, 102, 103 are busy or idle. The manager process keeps a local copy of the number of states handled, the total number of messages sent, and the total number of messages received by each node 101, 102, 103. If all nodes 101, 102, 103 are idle, the manager process ensures that no messages are being sent through system 100. Then, if all nodes 101, 102, 103 are idle and no messages are being sent, the manager process terminates method 200.

One embodiment of method 200 is illustrated in the pseudo-code below.

```
function Start(i, initial_state) {
V[i] := { }; /* set of already processed states in i^{th} node */
  U[i] := { }; /* set of states yet to processed in i^{th} node */
  canonicalized_initial_state := Canonicalize (initial_state);
  j := Partition (canonicalized_initial_state) ;
  if (j == i) U[i] := U[i] + canonicalized_initial_state ;
  Startnode (i) ;
  }
function Startnode (i) {
  while not asked to stop do {
    while U[i] is empty do wait;
    pending_state := extract a state from U[i] ;
    if (ErrorReporting (pending_state) ≠ Null) show errors;
    else DistributedDFS (i, pending_state) ;
  }
}
function DistributedDFS (i , state) {
  if state is not in V[i] {
      V[i] := V[i] + state ;
      for each sequential process P do {
        next := all transitions of P enabled in state ;
        for each transition in next do {
          successor_state := successor state of state after transition ;
          canonicalized_successor_state := Canonicalize (successor_state);
          j := Partition (canonicalized_successor_state) ;
          if (j == i)
            if (ErrorReporting (canonicalized_successor_state) ≠ Null) show errors;
              else DistributedDFS (j, canonicalized_successor_state) ;
            else U[j] := U[j] + canonicalized_successor_state ;
          }
        }
    }
  }
```

Here, the Start function is run only initially by a first node which has the initial state. Each other node starts running the function Startnode. V comprises a set of the processed states and each node (i) keeps track of the subset of processed states assigned to that node in V[i]. Similarly, U comprises a set of not yet processed states and each node (i) keeps track of the subset of unprocessed states for that node in U[i].

Although specific embodiments have been illustrated and described herein, it will be appreciated by those of ordinary skill in the art that any arrangement, which is calculated to achieve the same purpose, may be substituted for the specific embodiments shown. It is manifestly intended that any inventions be limited only by the claims and the equivalents thereof.

What is claimed is:

1. A method for checking a model of a system using a plurality of nodes, wherein the model comprises a plurality of states of the system, the method comprising:
determining whether a class representative for a state has been processed;
when the class representative for the state has not been processed, generating a successor state for the state;
determining which of the plurality of nodes is assigned to process the successor state; and
processing the successor state at the node of the plurality of nodes that is assigned to process the successor state.

2. The method of claim 1, further comprising:
determining a class to which the successor state belongs; and
wherein processing the successor state at a node determines whether a class representative for the class to which the successor state belongs has been processed.

3. The method of claim 1, further comprising:
when the class representative for the state has been processed, discarding the state.

4. The method of claim 1, further comprising:
when the class representative for the state has not been processed, determining if there are any errors in the state.

5. The method of claim 1, further comprising:
when the node that is assigned to process the successor state is a node other than the node that generated the successor state, sending a message from the node that generated the successor state to the node that is assigned to process the successor state, wherein the message comprises the successor state and class information for the successor state.

6. The method of claim 1, wherein determining which of a plurality of nodes is assigned to process the successor state further comprises:
determining which of a plurality of subsets the successor state belongs with; and
determining which of a plurality of nodes is assigned to process the successor state base on which of the plurality of nodes is assigned to the subset to which the successor state belongs.

7. The method of claim 1, further comprising:
determining a state space for a system to be modeled;
dividing the state space into a plurality of subsets;
assigning each subset to one of the plurality of nodes; and
determining a plurality of classes for the state space.

8. A system for checking a model of another system, the system comprising:
a plurality of nodes communicatively coupled together, each of the plurality of nodes comprising:
a processor to execute software;
a storage medium communicatively coupled to the processor from which the processor reads at least a portion of the software for execution thereby, wherein the software is configured to cause the processor to:
determine whether a class representative for a state has been processed;
when the class representative for the state has not been processed, generate a successor state for the state;
determine which of the plurality of nodes is assigned to process the successor state; and
when the node assigned to process the successor state is a different node, send the successor state to the different node.

9. The system of claim 8, wherein when the node assigned to process the successor state is the node that generated the successor state, process the successor state;

10. The system of claim 8, wherein the software is configured to cause the processor to:
determine a class to which the successor state belongs; and
wherein when the successor state is processed at a node, the node determines whether a class representative for the class to which the successor state belongs has been processed.

11. The system of claim 8, wherein the software is configured to cause the processor to:
discard the state when the class representative for the state has been processed.

12. The system of claim 8, wherein the software is configured to cause the processor to:
determine if there are any errors in the state when the class representative for the state has not been processed.

13. The system of claim 8, wherein the software is configured to cause the processor to:
when the node that is assigned to process the successor state is a node other than the node that generated the successor state, send a message from the node that generated the successor state to the node that is assigned to process the successor state, wherein the message comprises the successor state and class information for the successor state.

14. The system of claim 8, wherein to determine which of a plurality of nodes is assigned to process the successor state the software is configured to cause the processor to:
determine which of a plurality of subsets the successor state belongs with; and
determine which of a plurality of nodes is assigned to process the successor state base on which of the plurality of nodes is assigned to the subset to which the successor state belongs.

15. The system of claim 8, wherein a first node of the plurality of nodes comprises software configured to cause a processor at the first node to:
determine a state space for a system to be modeled;
divide the state space into a plurality of subsets;
assign each subset to one of the plurality of nodes; and
determine a plurality of classes for the state space.

16. A method for checking a model of a system comprising:
processing a plurality of states for the model with a plurality of nodes using a distributed model checking technique;
wherein each of the plurality of nodes uses symmetry reduction techniques to check if a representative state for a first state has been processed prior to processing the first state.

17. The method of claim 16, wherein each of the plurality of nodes determines which of the plurality of nodes is assigned to process the first state using a partition algorithm; and wherein the first state is processed with by the node assigned to the process the first state.

18. The method of claim 16, wherein each of the plurality of nodes performs symmetry reduction techniques using a canonicalization algorithm.

19. The method of claim 16, wherein the distributed model technique is a distributed depth first search algorithm.

20. The method of claim 16, wherein when a first node sends the first state to a second node for processing by the second node, the first node includes class information with the state such that the second node can perform symmetry reduction techniques on the first state prior to processing the first state.
